(19) United States
(12) Patent Application Publication
(10) Pub. No.: US 2011/0011846 A1
(43) Pub. Date: Jan. 20, 2011

(54) HEATING ELEMENT WITH TEMPERATURE CONTROL

(76) Inventors: Olaf Soerensen, Mainz (DE); Juergen Seng, Kelkheim (DE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/892,305

(22) Filed: Sep. 28, 2010

Related U.S. Application Data
(63) Continuation of application No. PCT/EP2009/002159, filed on Mar. 25, 2009.

(30) Foreign Application Priority Data
Mar. 28, 2008 (EP) 08 005 926.4

(51) Int. Cl. H05B 1/00

(52) U.S. Cl. 219/494

(57) ABSTRACT

A heating element is provided, comprising a heating unit, a heat transfer unit and a first temperature control element and a second temperature control element, a first temperature control element being provided at a first distance to the heating unit and the second temperature control element being provided at a second distance to the heating unit, wherein the first temperature control element has a first minimal activation threshold and the second temperature control element has a second minimal activation threshold, wherein the second distance is smaller than the first distance and the second threshold is higher than the first threshold, and the first temperature control element and a second temperature control element are both in immediate contact with the heat transfer unit. In further aspects, the invention relates to a method of heating an appliance by using a heating element and a method for providing a heating element.

### CROSS REFERENCE TO RELATED APPLICATIONS

This application is a continuation of prior co-pending International Application No. PCT/EP2009/002159 filed Mar. 25, 2009, designating the United States.

### FIELD OF THE INVENTION

The present invention concerns a heating element, which comprises a heating unit, a heat transfer unit and a first temperature control element and a second temperature control element. Heating units have proven useful in a large variety of applications. The heating units disclosed herein can for example be useful in ovens and other kitchen appliance, including in food warmers, water heaters, water kettles and coffee makers or toasters. They are also useful in other household appliances, including clothes dryers, irons, or hair dryers, hair straighteners or hair curlers. Other applications of the present invention include automotive applications and appliances, including car heaters, engine heaters, defrosters, and seat warmers. Yet other applications include reactor heaters and pipe heaters, and similar applications in the chemical engineering area.

### BACKGROUND OF THE INVENTION

WO 2007/131271 A1 discloses an improved temperature sensor for an electric heating vessel. The temperature sensor can be an electronic heating sensor being thermally insulated from the heat distribution plate, but in thermal communication with the contact plate.

EP 1 370 497 B1 discloses a sol-gel derived resistive and conductive coating. Disclosed is in particular a composition for application to a substrate to form a coating thereon, the composition comprising a sol-gel solution in which up to about 90% of said solution is a conductive powder.

In view of the prior art the present invention aims at providing an optimized heating element, which comprises a heating unit, a heat transfer unit, a first temperature control element and a second temperature control element. It is desired that the unit can be manufactured efficiently in a low-cost mass production process and that the temperature control elements are provided in a form optimized for such process and at the same time efficient for accurate and reliable temperature measurement and control.

### SUMMARY OF THE INVENTION

In summary, the present invention relates to: A heating element comprising a heating unit, a heat transfer unit and a first temperature control element and a second temperature control element, a first temperature control element being provided at a first distance to the heating unit and the second temperature control element being provided at a second distance to the heating unit, wherein the first temperature control element has a first minimal activation threshold and the second temperature control element has a second minimal activation threshold, wherein the second distance is smaller than the first distance and the second threshold is higher than the first threshold, and the first temperature control element and a second temperature control element are both in immediate contact with the heat transfer unit. In further aspects, the invention relates to a method of heating an appliance by using a heating element and a method for providing a heating element.

### BRIEF DESCRIPTION OF THE DRAWINGS

Embodiments of the present invention will be described below also with reference to the accompanying drawings in which:

FIG. 1 is a perspective view onto a heating element according to the present invention.

FIG. 2 is an on top view onto the heating element of FIG. 1.

FIG. 3 is a cross sectional view through the heating element of FIG. 1 along the axis indicated in FIG. 1.

FIG. 4 is another cross sectional view of the embodiment of FIG. 1 along the axis IV-IV indicated in FIG. 1.

### DETAILED DESCRIPTION OF INVENTION

The heating element of the present invention comprises a heating unit. The heating unit is the source of heat, and is typically provided as a resistive heater. The heating element further comprises a heat transfer unit. This unit is in thermal contact with the heating unit and able to transfer and disseminate heat. The heat transfer unit may also give mechanical stability to the overall heating element. The heating element further comprises a first temperature control element and a second temperature control element. The first temperature control element is provided at a first distance to the heating unit. This first distance is to be measured as the shortest distance from one edge of the first temperature control element to the next edge of the heating unit. The second temperature control element provided as at a second distance to the heating unit (to be measured as the first distance).

The first and the second temperature control element both react to a temperature present in the ambient area of the control element. This reaction can be a temperature dependent current and/or voltage output, an on/off signal and/or an on/off switch function.

The temperature control element can have a variety of forms. For example it can be an electric or electronic thermometer providing an output, for example in the form of a temperature dependent electrical voltage or current. Such control elements will often comprise a NTC- or PTC-element. They may also comprise a mechanical element, such as a bi-metal. Alternatively they may comprise a substance of a certain melting point, the melting of which will trigger a mechanical or electrical or electronic signal.

Some temperature control elements will have a minimal activation threshold. That threshold is to be understood as the minimal temperature value as of which a useful signal can be obtained. Such threshold may be well below room temperature, even as low as about 0° Kelvin or may also be above room temperature. For example, a temperature control element, which relies on the melting of a certain substance, will typically have an activation threshold above room temperature.

The present heating element comprises a first temperature control element which has a first minimal activation threshold and a second temperature control element which has a second minimal activation threshold. The second threshold is higher than the first threshold. Therefore, at a temperature below the second activation threshold only the first temperature control element will provide useful temperature reading.

The first temperature control element and the second temperature control element are both in immediate contact with the heat transfer unit.

As both elements are in immediate contact with the heat transfer unit, a reliable temperature reading can be assured. Especially in situations where temperatures exceeding certain upper temperatures are to be avoided, such immediate contact provides additional safety. If a certain upper temperature is to be avoided the second threshold can be selected below that upper temperature. When the temperature of the heating element as read on the heat transfer unit approaches the upper temperature, two temperature control elements are available as to ensure that that upper temperature is not exceeded. Given that the second temperature control element is closest to the heating unit, the reading of the second temperature control element is particularly reliable.

In one embodiment the first and the second temperature control element are both provided on the same surface of the heat transfer unit as the heating unit. Therefore, they can give a reliable reading of the temperature of the heating unit, even when temperature change is dynamic and readings from a more remote position, also on the heat transfer unit could give a delayed reading.

In another embodiment the first temperature control element and the second temperature control element are provided on two distinct surfaces of the heat transfer unit.

Given that the distance of the second temperature control element to the heating unit is less than the distance of the first temperature control element to the heating unit, the second temperature control element can still provide a reliable temperature reading, even when the first temperature control element is provided on a distinct surface of the heat transfer unit.

The heating element can comprise a heating unit which is provided on the heat transfer unit in the form of a coating. The heat transfer unit then serves as a carrier for this coating.

A variety of compositions can be useful for the coating. The coating can comprise or consist of an epoxy-based or glass-based composition.

Alternatively, the coating can comprise a composition comprising a sol-gel solution in which in up to 90% of said solution is a conductive powder in a uniform stable dispersion and said solution conductive powder is a member selected from the group consisting of metals, ceramics, interceramics and semi-conductors. Some suitable examples of those compositions can be found in EP 1 370 497 B1.

Alternative compositions suitable for the coating are sol-gel formulations comprising a slurry having up to 90% by weight of inorganic powder dispersed in a colloidal sol-gel solution prepared from metal organic precursors wherein the sol-gel solution has an expanded and preferably discontinuous gel network and the slurry or coating layer converts to a thick inorganic coating upon firing to a temperature of at least 300° C. and preferably less than 450° C.

Yet other suitable compositions are: conductive, resistive and dielectric inks, cermets (prepared from aluminium oxides or zirconium oxides in combination with metals (including niobium, molybdenum, titanium, and chromium)); mixtures of silver, lead, palladium, and ruthenium oxide, for example Ag Pb Pd Ru02, or Pb2Ru2O6, or Ag/Pd 65/35; alumina or aluminium nitride; or mixtures of aluminium oxide, aluminium nitride, beryllium oxide, silicon carbide, and nichrome.

Likewise, the temperature control elements can be provided on the heat transfer unit in the form of a coating. This coating can also be provided from the materials suitable for coatings listed above.

It is also possible that at least one or both temperature control elements comprise or even consist of the same composition as the heating unit.

The heating element can also comprise a third temperature control element. This third temperature control element can comprise or even consist of the same composition as the heating unit and/or the first temperature control element.

The heating element can be designed such that the distance of the first temperature control unit is considerably greater than the distance of the second temperature control unit, both as measured to the heating unit: For example, the first distance can be 50%, 100%, 150%, 200% greater than the second distance. In some cases the second distance can also be chosen very small, e.g. less than 3 mm, 2 mm or 1 mm or about 0 mm.

A heating element can be provided in which the second activation threshold is at least 100° C., 150° C., 200° C. or 250° C. higher than the first threshold. In such an element the large temperature range is provided, where control with the help of one temperature control element is sufficient and the second temperature control element can serve to prevent overheating situations.

The heat transfer unit can have a multitude of shapes and can be provided from a multitude of materials. For example a cubic or rhombic shape is suitable for the heat transfer unit. Also can the heat transfer unit have a cylindrical or semi-cylindrical shape. A variety of materials with good heat transfer is suitable for the heat transfer unit. The heat transfer unit will often be provided from a metal, such as aluminium or from mica-based material. At least one surface of the heat transfer unit can have a coating, for example a ceramic coating or an aluminium oxide coating.

Where the heat transfer unit is provided from an electrically conductive material an electrical insulator can be placed between the heat transfer unit and the heating unit and the at least one temperature control element, respectively. Such an electrical insulator can be provided in the form of a coating on at least one surface of the heat transfer unit.

It is also within the scope of the present invention to provide a multi-piece heat transfer unit. For example, a three-piece-unit can be provided, in which one piece carries the heating unit and the two other pieces each carry a temperature control element. These units can be mounted together, e.g. adhered or clamped, as to achieve a good physical connection without having a strong thermal communication.

A weaker thermal communication between the heating unit and at least one temperature control element will yield a temperature reading which is more representative of the average temperature of the heat transfer unit and/or the heating element as a whole than of the temperature at the heating unit itself.

The heating element can be used for low voltage applications, for example the voltage to operate the heating unit can be chosen in the range of 1 to 250 V, or 200 to 250 V, or 90 to 120 V, or 30 to 50 V, or 10 to 14 V. The heating element has been found to operate very satisfactorily when operated at a voltage in the range of 0 to 50 V or 30 to 50 V or 35 to 45 V. Without wishing to be bound by theory, it is considered possible, that such voltage range allows a sufficiently fast heating without that heating power is such, that the temperature reading becomes less reliable.

In one aspect, therefore, the present invention concerns a method of heating an appliance at a voltage selected from the ranges above using the heating element of claim 1 filed herewith or any of its dependent claims. Suitable appliances include kitchen appliances including food warmers, water heaters, water kettles, coffee makers, and toasters. Also included are all household appliances including cloth dryers or cloth treatment appliances, irons, and hair dryers, hair straighteners and hair curlers.

The present invention in another aspect comprises a method for providing a heating element. This method comprises a step of providing a heat transfer unit and a step of providing a heating unit. The method comprises a further step of providing a first temperature control element which has a first minimal activation threshold and a first distance to the heating unit and is provided in immediate contact with the heat transfer unit. The method comprises a further step of providing a second temperature control element which a second minimal activation threshold higher than the a first minimal activation threshold and being provided at a second distance to the heating unit, such that the second distance is smaller than the first distance and such that the second temperature control element in immediate contact with the heat transfer unit.

The heating unit and the first temperature control element can both be provided in one process step. Alternatively, these two units can be provided in to separate process steps in either sequence. The method for providing a heating element can also comprise a step of providing the heating unit and the first temperature control element in the form of coatings each.

The heating unit and the first temperature control element can be applied by spraying, brushing, dipping or screen printing. This is of particular benefit, when the elements are provided in the forms of coatings. Also the second temperature control element can be provided by spraying, brushing, dipping or screen printing.

The second temperature control element can be provided for example by screen printing a metal of a low melting point, for example tin. This low melting point metal can serve to trigger a temperature control effect.

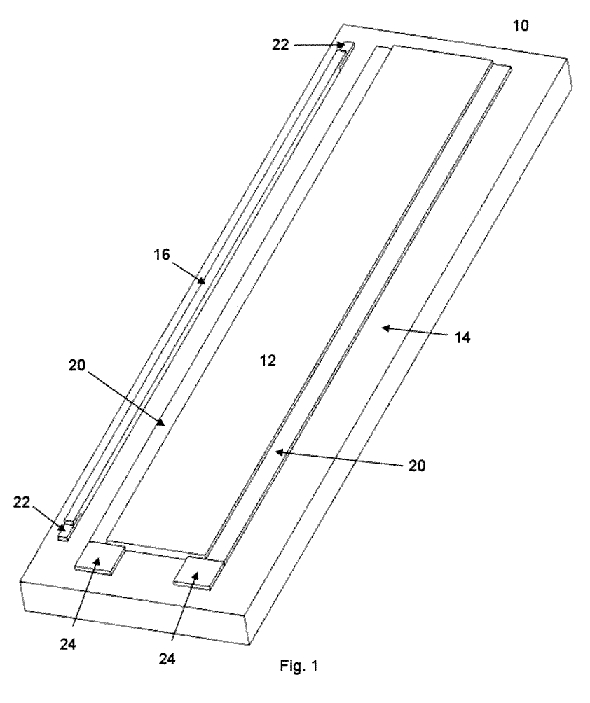

FIG. 1 shows a heating element (10) for which the heat transfer unit (14) is provided in form of a cuboid. One large surface of the cuboid is used for the heating unit (12) and for providing a first temperature control element (16). Both units are provided as coatings carried by the heat transfer unit (14). Both units in themselves also have (at least essentially) the form of a cuboid. A second temperature control element (24) is provided on the same surface.

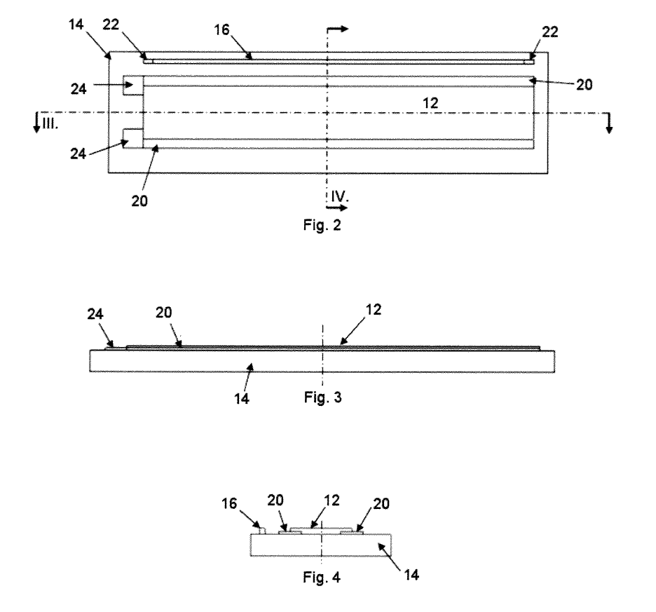

In the corresponding on top view of FIG. 2 the heating unit appears as a rectangle with a major axis and a minor axis. The first temperature control element (16) is disposed adjacent to the heating unit (12) and also appears in the form of a rectangle. The rectangle has a major axis, which is as long as those corresponding axis of the heating units. The rectangle has a minor axis which is shorter than the minor axis of the heating unit. The respective minor axis can measure 50%, or 25% or 10% or less of the corresponding axis of the heating unit (12).

The distance of the first temperature control element (16) to the heating unit can be chosen to the about 50%, or 25%, or 10%, or less of the length of the minor axis of the heating unit (12).

It is apparent from FIGS. 1 and 2, the distance of the first temperature control element (16) to the heating unit (12) is greater than the distance of the second temperature control element (24), as the second temperature control element (24) is adjacent to the heating unit (12).

Heating electrodes (20) are provided as to electrically contact the heating unit (12). These electrodes can be provided adjacent to each of the minor axes or (as shown) of the major axes of the heating unit (12). They can be provided in the form of a layer of conductive material, e.g. between the heating unit (12) and the heat transfer unit (14).

Further electrodes (22) are provided as to electrically contact the first temperature control element (16).

FIG. 3 provides a cross sectional view of the heating element (10). It is apparent from FIG. 3 that the surface area of the heat transfer unit is only partly covered by the heating unit (12).

FIG. 4 gives another cross sectional view, from which it is apparent that the first temperature control element (16) can be disposed adjacent to the heating unit (12) on one surface of the heat transfer unit.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

What is claimed is:

1. A heating element comprising a heating unit, a heat transfer unit and a first temperature control element and a second temperature control element, a first temperature control element being provided at a first distance to the heating unit and the second temperature control element being provided at a second distance to the heating unit, wherein the first temperature control element has a first minimal activation threshold and the second temperature control element has a second minimal activation threshold, wherein the second distance is smaller than the first distance and the second threshold is higher than the first threshold, and the first temperature control element and a second temperature control element are both in immediate contact with the heat transfer unit.

2. A heating element according to claim 1, wherein the first temperature control element and the second temperature control element are both provided on the same surface as the heating transfer unit.

3. A heating element according to claim 1, wherein the first temperature control element and the second temperature control element are provided on two distinct surfaces of the heat transfer unit.

4. A heating element according to claim 1, wherein the heating unit is provided on the heat transfer unit in the form of a coating.

5. A heating element according to claim 1, wherein heating unit is provided in the form of a sol-gel composition.

6. A heating element according to claim 1, wherein the temperature control element is provided on the heat transfer unit in the form of a coating.

7. A heating element according to claim 1, wherein the temperature control element is provided in the form of a sol-gel composition.

8. A heating element according to claim 1, wherein the temperature control element comprises or consists of the same composition as the heating unit.

9. A heating element according to claim 1, wherein the first distance is at least 100% greater than the second distance.

10. A heating element according to claim 1, wherein the second threshold is at least 200° C. higher than first threshold.

11. A method of heating an appliance by using a heating element comprising a heating unit, a heat transfer unit and a first temperature control element and a second temperature control element, a first temperature control element being provided at a first distance to the heating unit and the second temperature control element being provided at a second distance to the heating unit, wherein the first temperature control element has a first minimal activation threshold and the second temperature control element has a second minimal activation threshold, wherein the second distance is smaller than the first distance and the second threshold is higher than the first threshold and the first temperature control element and a second temperature control element are both in immediate contact with the heat transfer unit, wherein the heating unit is operated at a voltage in the range of 30 V to 50 V.

12. A method for providing a heating element, the method comprising the following steps:
providing a heat transfer unit
providing a heating unit
providing a first temperature control element in immediate contact with the heat transfer unit, the first temperature control element having a first minimal activation threshold and a first distance to the heating unit
providing a second temperature control element in immediate contact with the heat transfer unit the second temperature control element having a second minimal activation threshold higher than the a first minimal activation threshold and having at a second distance to the heating unit, the second temperature control element being provided such that the second distance is smaller than the first distance.

13. The method for providing a heating element according to claim 12, in which the heating unit and the first temperature control element are both provided in one process step.

14. The method for providing a heating element according to claim 1, in which the heating unit and the first temperature control element are both provided in the form of a coating.

15. The method for providing a heating element according to claim 1, in which the heating unit and/or the first temperature control element is applied by spraying, brushing, dipping or screen-printing.
